(19) United States
(12) Patent Application Publication
(10) Pub. No.: US 2009/0128992 A1
(43) Pub. Date: May 21, 2009

(54) MOS CAPACITOR STRUCTURE AND LINEARIZATION METHOD FOR REDUCED VARIATION OF THE CAPACITANCE

(75) Inventors: Nikolaos C. Haralabidis, Athens (GR); Ioannis G. Kokolakis, Holargos (GR)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 11/942,344

(22) Filed: Nov. 19, 2007

(51) Int. Cl. H01G 4/38

(52) U.S. Cl. 361/329

(57) ABSTRACT

A highly linearized capacitor structure is formed by a first capacitor, that is coupled between a first terminal and a common node, combine with a second capacitor, that is coupled between a second terminal and the common node. When a bias voltage is applied, the capacitance values of the first and second capacitors combine and a capacitance variation of the first capacitor is compensated by a capacitance variation of the second capacitor to reduce and linearize overall capacitance variation in the combined capacitor structure.

### BACKGROUND OF THE INVENTION

1. Technical Field of the Invention

The present invention relates generally to MOS capacitors and, more particularly, to MOS capacitors for use in wireless devices.

2. Description of Related Art

Metal-Oxide-Semiconductor (MOS) capacitors are capacitor structures implemented using MOS technology. A typical structure of a MOS capacitor is shown in FIG. 1. Generally, a gate oxide layer 11 resides between a gate (G) 12 and a substrate 13, in which the gate and the substrate (also referred to as bulk material) function as the two plates of a capacitor with the gate oxide material functioning as the dielectric between the two plates. The substrate may be formed from a variety of materials, but for MOS technology, the substrate is typically silicon. Substrate 13 of FIG. 1 is designated as “B” for Bulk material. In forming MOS capacitors, the structure is designed similar to a field-effect-transistor (FET) with source (S) and drain (D) regions separated by a channel region that underlies Gate OX 12. The gate forms one plate contact. An ohmic contact to the source, drain and channel regions are coupled together to form the second plate terminal of the capacitor.

Although capacitors may take on various characteristics, FIG. 2 shows a common response curve for capacitance C as a function of bias voltage. The bias voltage is shown as the gate-to-substrate voltage V_{GB} in FIG. 2. The curve is described with reference to a n-type MOS (NMOS) device, but is equally applicable to p-type (PMOS) devices. In FIG. 2, response curve 20 is separated into three regions 21, 22, 23. Accumulation region 21 pertains to a condition when V_{GB} is less than V_{FB} (Flat Band Voltage), where the negative charge on the gate attracts positive carriers (holes) from the substrate to accumulate under the gate to form the capacitor bottom plate underlying the gate oxide. Inversion region 22 pertains to a condition when V_{GB} is greater than the threshold voltage Vth, where the positive charge on the gate attracts negative carriers (electrons) to form a conductive channel underlying the gate oxide. The region between accumulation region 21 and inversion region 22 is referred to as a depletion region where V_{FB}<V_{GB}<Vth. Depletion region 23 pertains to a condition where positive charges on the gate push the holes into the substrate and deplete mobile carriers at the interface.

As noted in curve 20, the capacitance value varies significantly for the depletion region where V_{FB}<V_{GB}<Vth. Generally, when MOS capacitors are used in a circuit, V_{GB} is set to have the operating point in accumulation region 21 or inversion region 22, where the capacitance approaches Cox (capacitance of the oxide). The capacitance values exponentially reach substantially the same value Cox at the ends of the two regions 21, 22, so the operating point of the capacitor is selected in the tail portions of the operating curve. However, even though the response curve 20 appears flatter at the two tail regions of curve 20, a substantial (exponential in this instance) variation in capacitance may still be noted in respect to slight changes in the bias voltage. Because of this variation, the capacitor may not have an adequate stable or linearized response for certain applications. For circuits such as oscillators, phase-locked loops (PLLs), tuning engines, as well as others, that utilize MOS capacitors in the circuitry, a high variation of capacitance value may not be desirable. For proper operation, the capacitance in these types of circuitry should remain fairly stable.

Accordingly, in certain applications, the MOS capacitor of FIG. 1 still may have too much variation in the capacitance value for the intended circuit. Thus, capacitors with highly stable capacitance values are useful and a need exists for a capacitor structure that provides a highly stable response.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE DRAWINGS

FIG. 1 is a diagram showing a prior art MOS capacitor.

FIG. 2 is a prior art response diagram when a bias voltage is applied to the MOS structure of FIG. 1.

FIG. 3 is a circuit diagram showing one embodiment of a highly linearized MOS capacitor structure of the present invention, in which two MOS capacitors are combined to operate together to provide a highly linearized and reduced variation response.

FIG. 4 is a response diagram when a bias voltage is applied to the MOS capacitor structure of FIG. 3.

FIG. 5 is an enlarged diagram showing a portion of the diagram of FIG. 4 where characteristics of the two capacitors combine to provide a resultant combined capacitance.

FIG. 6 is an alternative embodiment for the two capacitor structure of FIG. 3, for use with a bulk substrate.

FIG. 7 is a response curve for the structure of FIG. 6 showing a shift in the capacitance behavior due to an additional voltage applied to the bulk substrate.

FIG. 8 is a diagram showing characteristics of the two capacitors of FIG. 6 when combined to provide a resultant combined capacitance with a bias shift.

### DETAILED DESCRIPTION OF THE EMBODIMENTS OF THE INVENTION

The embodiments of the present invention may be practiced in a variety of settings that implement a Metal-Oxide-Semiconductor (MOS) capacitor structure. The specific embodiments described below pertain to an n-type MOS (NMOS) device, but is equally applicable to p-type (PMOS) devices as well. Generally, MOS capacitors are manufactured using a silicon substrate, however, the capacitor structure may be readily adapted to other technologies that use other substrate materials.

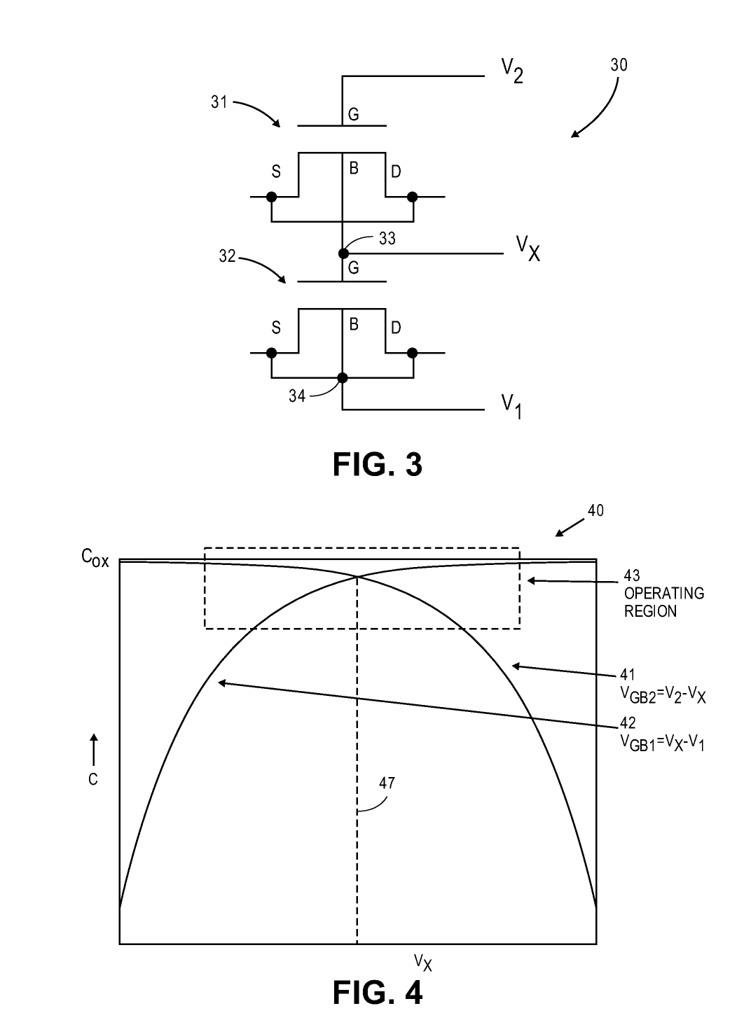

FIG. 3 illustrates one embodiment of the invention in which two MOS capacitors are coupled together to combine their characteristics to provide a more linearized and reduced variation response over the single prior art capacitor of FIG. 1. In FIG. 3, a MOS capacitor structure 30 is shown comprised of MOS capacitor 31 and MOS capacitor 32. In this example, both capacitors 31, 32 are n-type (NMOS) devices. However, as noted below, the capacitor structure may be constructed using p-type (PMOS) capacitors as well. The two capacitors are formed similar to MOS transistors, in that source, drain and channel regions are formed, in which source and drain regions are coupled together. As noted below, the substrate region underlying the gate where the channel region is formed may be coupled to the source and drain, as well.

Each capacitor 31, 32 is shown having its source (S), drain (D) and channel substrate (B) coupled together to form one terminal of the capacitor, while its gate (G) forms the other terminal. The gate oxide underlying the gate operates as the dielectric material of the capacitor. It is to be noted various capacitive structures may be used for capacitors 31, 32. The prior art capacitor of FIG. 1 may also be adapted for use as well. As shown in FIG. 3, the gate of capacitor 31 is coupled to a voltage V₂, while the S, D and B of capacitor 31 are coupled to node 33 to form the opposite terminal of capacitor 31. Node 33 is coupled to voltage Vx. The gate of capacitor 32 is also coupled to node 33 and voltage Vx, while the S, D, B terminal of capacitor 32 is coupled to node 34 and voltage V₁. Therefore, capacitors 31 and 32 are coupled in series between V₂ and V₁, and node 33 operates as the common node between the two capacitors.

For one embodiment using NMOS capacitors, V₂ is more positive than V₁. For example, in one embodiment, V₂ is coupled to a supply voltage, such as Vdd, and V₁ is coupled to a supply return, such as Vss or ground. In other embodiments, the voltages may be different. With the two capacitor structure 30 of FIG. 3, a combined capacitor structure may be obtained with node 33 as one terminal of the combined capacitor and the supply terminals V₁ and V₂ forming the other terminals of the respective capacitors. That is, node 33 forms one terminal of the combined capacitor structure and V₁ and V₂ terminals form the opposite terminal of the combined capacitor structure. In essence, capacitors 31 and 32 are in parallel between node 33 and the supply terminals. Because the two capacitors are in parallel, the resultant capacitance is the combined capacitance of capacitors 31, 32.

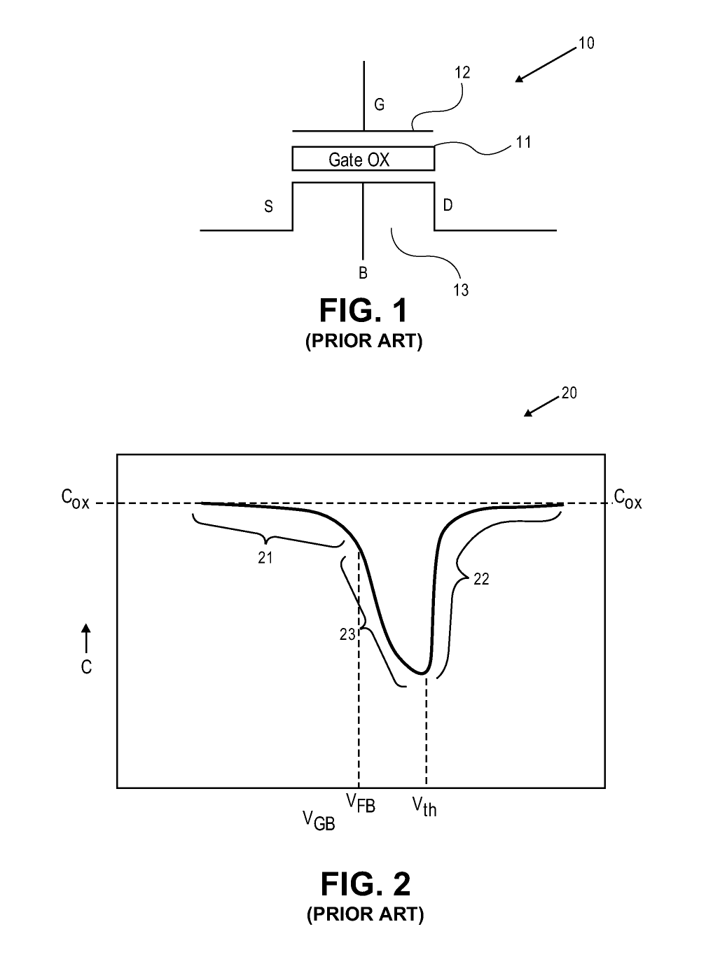

When each of the capacitors 31, 32 has a response curve similar to the MOS response curve shown in FIG. 2, voltage Vx may be selected as a bias voltage for the two capacitors. That is, capacitor 31 would have a V_{GB} voltage that may be determined as V_{GB2}=V₂−Vx. Likewise, a V_{GB} voltage for capacitor 32 may be determined as V_{GB1}=Vx−V₁. The response curves for the two capacitors are shown in diagram 40 of FIG. 4. Diagram 40 shows capacitance versus bias voltage V_{X} for each capacitor 31, 32. With V₁ and V₂ set substantially to voltages noted above, curve 41 shows the capacitance value for capacitor 31 as a function of V_{GB2}, while curve 42 shows the capacitance value for capacitor 32 as a function of V_{GB1}. Note that the capacitors are biased to operate in the inversion region, but that curve 41 is reversed since the common terminal at node 33 is at the substrate side of capacitor 31, whereas for capacitor 32 the common terminal 33 is at the gate. Dotted line 47 indicates the value of Vx at the intersection of curves 41, 42, where the capacitances of capacitors 31, 32 are approximately equal. In one embodiment, this midpoint has an approximate value (V₂−V₁)/2. When Vx increases above this midpoint, capacitor 32 is the main contributor to the overall capacitance and when Vx decreases below the midpoint, capacitor 31 is the main contributor. The capacitance values of each capacitor 31 and 32 approaches Cox as V_{GB} of each capacitor (noted as V_{GB1} and V_{GB2}) approaches the ends of each curve 41, 42.

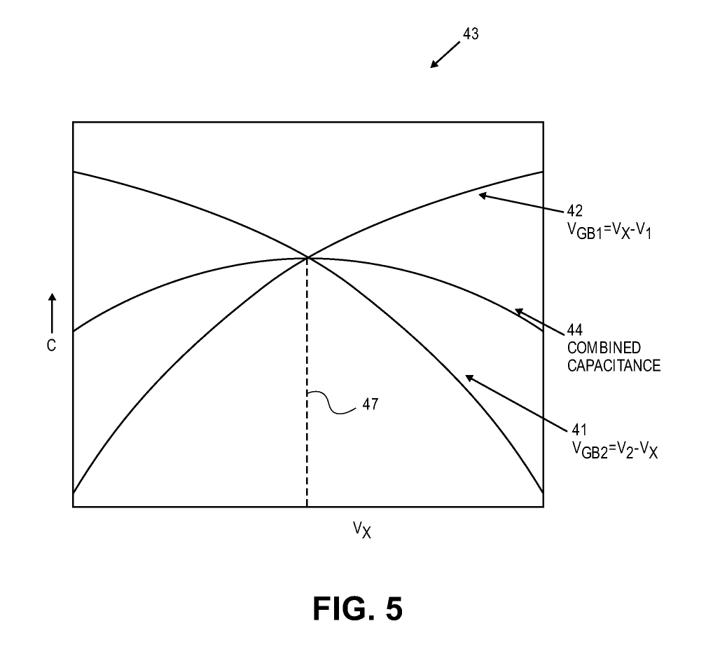

Because the two capacitors are disposed in parallel respect to node 33, capacitor structure 30 has a response that is cumulative of the two curves 41, 42. If proper voltage selection for Vx is made, an operating region 43 may be selected that is near the intersection of the two curves 41, 42, which is proximal to the two curves approaching the final value of Cox. FIG. 5 is an enlarged illustration of region 43.

As shown in FIG. 5, curve 41 has a certain slope depicting a change in capacitance to a change in its V_{GB} (noted as V_{GB2}). Similarly, curve 42 also has a certain slope depicting a change in capacitance to a change in its V_{GB} (noted as V_{GB1}). Since the two capacitances add, the resulting average of the combined capacitances of capacitors 31 and 32 is represented by curve 44. Curve 44 has less of a slope than either curve 41 or 42. Thus, the combined capacitance values of capacitors 31, 32 results in a flatter curve 44. Curve 44 has a smaller variation in capacitance as V_{GB} changes, as compared to either curve 41 or 42. Since the two capacitors are in parallel and their capacitances add, a desired target capacitance value for structure 30 may be selected by combining capacitances of the two capacitors.

As was described with reference to the prior art capacitor 10 of FIG. 1, use of a single capacitor (whether operating in the accumulation region or the inversion region) in a circuit results in a response characteristics that varies the capacitance value at a certain rate as the bias voltage V_{GB} changes. This change may have a significant slope so that small variation of the bias voltage may cause large changes in the capacitance value. However, by utilizing the combined capacitor structure of FIG. 3, the response characteristic of one capacitor is compensated by the response characteristic of a second capacitor to have a overall flatter capacitance response and, therefore, present a more linear slope so that changes in the bias voltage (notably V_{GB}) results in much smaller variations of the capacitance value. With the two capacitor structure 30 of FIG. 3, capacitors 31, 32 may be appropriately sized so that the target capacitance may be obtained by the combined capacitance values of the two capacitors. Generally, optimum results may be obtained when Cox values of capacitors 31 and 32 are equal.

As an example, in one capacitive structure, if the mean value is selected as the operating point of the intersection of the two curves 41, 42, curves 41 or 42 each alone could have a variation from the mean of approximately ±6.5%. However, the combined curve 44 may reduce that variation from the mean value to approximately ±1.5%. Accordingly, the total capacitance provided by the dual capacitor structure 30 may be linearized by a factor of 4.3 over a single capacitor. The large deviations noted in the operating range of each curve 41, 42 may be reduced or alleviated, as noted by curve 44.

In the manufacture of MOS devices, a typical practice is to place the source, drain and channel regions of MOS devices in an isolated well within the substrate. The local isolation enhances the performance of the device. Thus, the coupling shown for capacitor 30 is typically associated with the formation of substrate wells (such as n-wells). However, if no local isolation is utilized, then the device substrate is the bulk substrate. In order to provide isolation from the bulk substrate, an alternative coupling technique may be used.

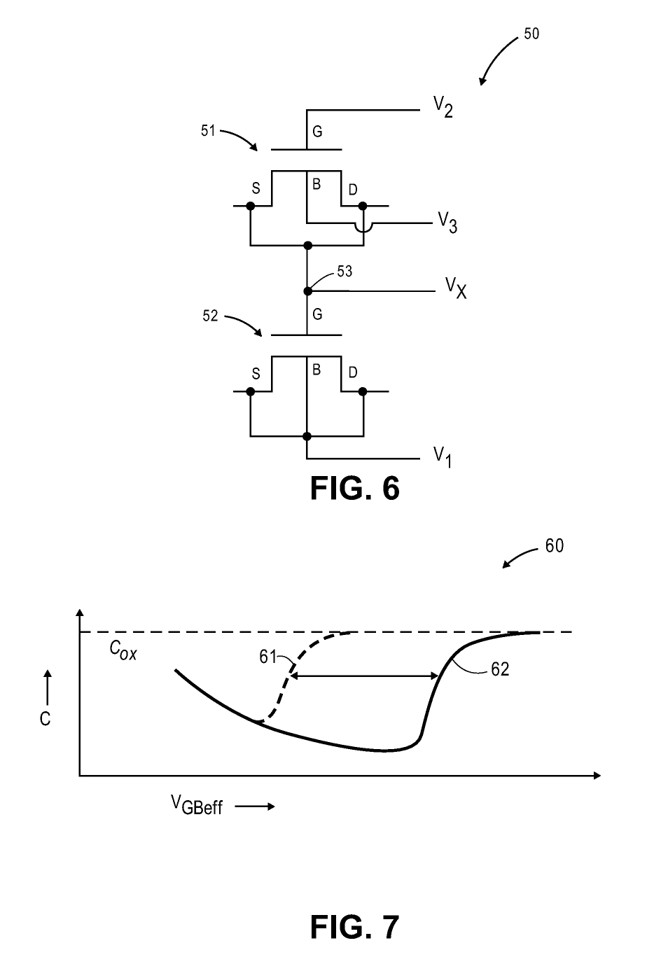

FIG. 6 shows an alternative embodiment for practicing the invention. The formed capacitor structure 50 uses transistors 51, 52, which are equivalent to transistors 31, 32, respectively. However, in this instance, the bulk substrate connection for the first MOS capacitor 51 is not coupled together with the source and the drain. Source and drain connections are still made to Vx at node 53, but the bulk substrate (B) connection for transistor 51 is made to a separate connection V₃. The voltage V_{GB} for transistor 51 is determined as V_{GB}=V₂−V₃. Voltage V₃ may be set to various values and in one embodiment V₃ is made approximately equal to V₁.

The effective capacitance at node 53 now also depends on the voltage difference between Vx and V₃. The effective V_{GB} or V_{GBeff}=V₂−Vx−(Vx−V₃), which is V₂−2Vx+V₃. For the inversion region still holds that V2−V3 is greater than the threshold voltage Vth. The resulting shift of the capacitance curve, due to the introduction of V₃, is shown in diagram 60 of FIG. 7. As noted, a response curve 61 showing capacitance as a function of V_{GB} is shifted by Vx−V₃ to provide a new shifted response curve 62.

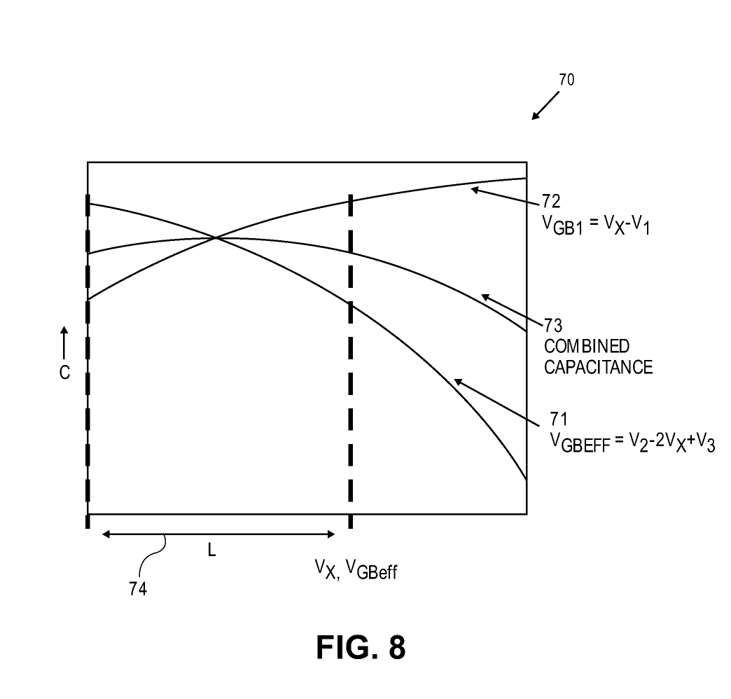

FIG. 8 shows a diagram 70, which depicts the response of capacitor structure 50. Diagram 70 is equivalent to the diagram of FIG. 5, but now has a reduced operating range 74, noted by length L for the combined capacitance of structure 50. The operating response of capacitor 52 is still determined by V_{GB1}=V_{X}−V₁ (similar to capacitor 32). However, the operating response of capacitor 51 is determined by V_{GBeff}=V₂−Vx−(Vx−V₃) (instead of V₂−V_{X}). The limitation introduced by the presence of V_{GBeff} essentially shrinks the operating area of capacitor structure 50. Although, the reduction in the operating region may result with the circuit configuration of capacitor structure 50, a linearized MOS capacitor structure implementing one technique of the present invention may still be constructed in a bulk substrate without the use of protected wells.

Accordingly, a MOS capacitor structure with reduced and linearized variation of the capacitance is described. The above-described embodiments used a NMOS capacitor in the various examples. However, the invention may be implemented using PMOS devices as well. Generally, the voltage polarities are reversed. Thus, for implementing capacitor structure 30 using PMOS devices, voltages V₁ and V₂ would be reversed for the circuit shown in FIG. 3 when capacitors 30, 31 are PMOS devices. Furthermore, other process technologies may be employed as well to construct the capacitor structures. It need not be limited to MOS technology. Additionally, the examples above described two capacitor structures. However, in other embodiments, more than two capacitors may be used to obtain the combined linearized capacitor structure. Many other structures may be readily adapted to practice the present invention.

The various embodiments of the present invention may be implemented in a variety of circuits and devices. Circuits such as oscillators, phase-locked loops (PLLs), tuning engines, filters, as well as others, may utilize the highly linearized MOS capacitors in the operation of the circuitry. These types of circuits are utilized in radio frequency (RF) front-ends and frequency conversion modules of wireless communication devices, so that use of the highly linearized capacitor improves the response and performance of these devices. In many instances, the RF circuitry is constructed on an integrated circuit chip, which may be manufactured using MOS technology.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

We claim:

1. An apparatus comprising:
a first capacitor coupled between a first terminal and a common node; and
a second capacitor coupled between a second terminal and the common node, in which the first and second capacitors form a capacitor structure that combines capacitance values of the first and second capacitors when a bias voltage is applied to the common node and to have a capacitance variation of the first capacitor compensated by a capacitance variation of the second capacitor to reduce overall capacitance variation in the combined capacitor structure.

2. The apparatus of claim 1, wherein the first and second capacitors are in parallel with each other.

3. The apparatus of claim 2, wherein the first and second capacitors are metal-oxide-semiconductor (MOS) capacitors.

4. The apparatus of claim 3, wherein the capacitor structure is implemented in a wireless communication device.

5. An apparatus comprising:
a first capacitor constructed in a form of a transistor and coupled between a first terminal and a common node, in which a gate of the first capacitor is coupled to the first terminal and source, drain and channel substrate of the first capacitor is coupled to the common node; and
a second capacitor constructed in a form of a transistor and coupled between a second terminal and the common node, in which a gate of the first capacitor is coupled to the common node and source, drain and channel substrate of the second capacitor is coupled to the second terminal node, wherein the first and second capacitors form a capacitor structure that combines capacitance values of the first and second capacitors when a bias voltage is applied to the common node and to have a capacitance variation of the first capacitor compensated by a capacitance variation of the second capacitor to reduce overall capacitance variation in the combined capacitor structure.

6. The apparatus of claim 5, wherein the common node operates as one plate terminal of the capacitor structure and the first and second terminals operate as opposite plate terminal of the capacitor structure when the bias voltage is applied.

7. The apparatus of claim 6, wherein the first and second capacitors are in parallel with each other, so that a capacitance value of the capacitor structure is determined by the combined capacitance values of the first and second capacitors.

8. The apparatus of claim 7, wherein the capacitance value of the capacitor structure approaches capacitance value of a gate oxide material resident in the first and second capacitors.

9. The apparatus of claim 8, wherein the first and second capacitors are metal-oxide-semiconductor (MOS) capacitors.

10. An apparatus comprising:
a first capacitor constructed in a form of a transistor and coupled between a first terminal and a common node, in which a gate of the first capacitor is coupled to the first terminal, source and drain of the first capacitor is coupled to the common node, and a substrate region underlying the gate of the first capacitor is coupled to a third terminal; and
a second capacitor constructed in a form of a transistor and coupled between a second terminal and the common node, in which a gate of the first capacitor is coupled to the common node and source, drain and substrate region underlying the gate of the second capacitor is coupled to the second terminal node, wherein the first and second capacitors form a capacitor structure that combines capacitance values of the first and second capacitors when a bias voltage is applied to the common node and to have a capacitance variation of the first capacitor compensated by a capacitance variation of the second capacitor to reduce overall capacitance variation in the combined capacitor structure.

11. The apparatus of claim 10, wherein a voltage is applied to the third terminal when bulk substrate material forms the substrate regions underlying the first and second gates.

12. The apparatus of claim 11, wherein the common node operates as one plate terminal of the capacitor structure and the first and second terminals operate as opposite plate terminal of the capacitor structure when the bias voltage is applied.

13. The apparatus of claim 12, wherein the first and second capacitors are in parallel with each other, so that a capacitance value of the capacitor structure is determined by the combined capacitance values of the first and second capacitors.

14. The apparatus of claim 13, wherein the capacitance value of the capacitor structure approaches capacitance value of a gate oxide material resident in the first and second capacitors.

15. The apparatus of claim 14 wherein the first and second capacitors are metal-oxide-semiconductor (MOS) capacitors.

16. A method comprising:
forming a first capacitor coupled between a first terminal and a common node; and
forming a second capacitor coupled between a second terminal and the common node, in which the first and second capacitors form a capacitor structure that combines capacitance values of the first and second capacitors when a bias voltage is applied to the common node and to have a capacitance variation of the first capacitor compensated by a capacitance variation of the second capacitor to reduce overall capacitance variation in the combined capacitor structure.

17. The method of claim 16, wherein forming the first and second capacitors includes forming the first and second capacitors as metal-oxide-semiconductor (MOS) capacitors.

18. The method of claim 17, wherein forming the first and second capacitors includes forming the capacitor structure in a wireless communication device.
